(19) United States
(12) Patent Application Publication
(10) Pub. No.: US 2019/0148984 A1
(43) Pub. Date: May 16, 2019

(54) Indoor to Outdoor Wireless Power Delivery

(71) Applicant: Google LLC, Mountain View, CA (US)

(72) Inventors: Peter J. Bevelacqua, Sunnyvale, CA (US); Jacobi Colton Grillo, San Francisco, CA (US); Ryan Kristopher Green, Palo Alto, CA (US); Daniel Adam Warren, San Francisco, CA (US); Brian Mitchell Silverstein, San Carlos, CA (US)

(73) Assignee: Google LLC, Mountain View, CA (US)

(21) Appl. No.: 16/107,893

(22) Filed: Aug. 21, 2018

Related U.S. Application Data
(60) Provisional application No. 62/584,558, filed on Nov. 10, 2017.

(51) Int. Cl. H02J 50/23; H02J 50/27; H04W 52/04

(52) U.S. Cl. CPC H02J 50/23; H04W 52/04; H02J 50/27

(57) ABSTRACT

In aspects, indoor to outdoor wireless power delivery is described that provides continuous power through a building structure. A transmitter receives an indication of a required continuous power from a receiver, configures one or more settings to generate an electromagnetic field to transfer the required continuous power, and generates the electromagnetic field to transfer the required continuous power to the receiver. In other aspects of indoor to outdoor wireless power delivery, a transmitter and a receiver are aligned to provide continuous power through a building structure. The transmitter and the receiver enter an alignment mode, the transmitter produces an electromagnetic field to inductively transfer power to the receiver, and the receiver senses the electromagnetic field produced by the transmitter and provides an indication of an alignment of the transmitter and the receiver to a user of the system.

### BACKGROUND

Smart-home systems, such as home automation or security systems, use wirelessly-connected devices that are located both inside and outside of the structure of the home. Some devices in these systems, such as sensors, operate on battery power for extended periods of time. However to provide an acceptable user experience, other devices, such as cameras, may require higher continuous power than can practicably be provided by batteries. When deployed indoors, electrical outlets in the structure provide numerous sources of continuous power for devices, however, there are typically fewer options for outdoor power sources. In addition to mounting a device, the conventional user experience for deploying outdoor devices may include determining suitable routing of the cables from indoor power sources to outdoor locations, drilling holes through the structure for cables, suitably installing the cables to avoid water penetration into the structure (e.g., forming cable drip loops), and weatherproofing the holes in the structure. Conventional installations may require skills an end user lacks, or if installed by a professional contractor, may increase the cost of deploying a smart home system.

### SUMMARY

This summary is provided to introduce simplified concepts of indoor to outdoor wireless power delivery. The simplified concepts are further described below in the Detailed Description. This summary is not intended to identify essential features of the claimed subject matter, nor is it intended for use in determining the scope of the claimed subject matter.

In an aspect, a device for indoor to outdoor wireless power delivery is described, in which an electronic device that includes a transmitter and a receiver inductively transfers continuous power from an indoor environment to an outdoor environment. The transmitter includes a transmitter coil, a transmitter housing, and transmitter electronics that are configured for operation in the indoor environment and configured to produce an electromagnetic field to inductively transfer power to the receiver. The receiver includes a receiver coil, a receiver housing, and receiver electronics that are configured for operation in the outdoor environment and configured to receive the electromagnetic field from the transmitter.

In another aspect, a method of inductively transferring continuous power from a transmitter device to a receiver device is described in which the transmitter device receives an indication of a required continuous power from the receiver device. The transmitter device configures one or more settings to generate an electromagnetic field to transfer the required continuous power and based on the one or more settings, generates the electromagnetic field to transfer the required continuous power to the receiver device.

In a further aspect, a system for inductive power transfer is described that includes a transmitter apparatus and a receiver apparatus. The transmitter apparatus includes a transmitter controller to configure the transmitter apparatus, a regulator that is configurable by the transmitter controller to set a voltage to be applied to a transmitter coil, the transmitter coil that is configured to generate an electromagnetic field, and a coil driver that is configurable by the transmitter controller to provide a current flow to the transmitter coil. The receiver apparatus includes a receiver controller to configure the receiver apparatus, a receiver coil that is configured to receive an electromagnetic field from the transmitter apparatus, a rectifier to convert an alternating current from the receiver coil to a direct current, and an output regulator that is configurable by the receiver controller to set an output voltage to be provided to an external electronic device.

### BRIEF DESCRIPTION OF THE DRAWINGS

Aspects of indoor to outdoor wireless power delivery are described with reference to the following drawings. The same numbers are used throughout the drawings to reference like features and components:

FIG. 1 illustrates an example environment in which various aspects of indoor to outdoor wireless power delivery can be implemented.

FIG. 2 illustrates an example exterior view of a transmitter and a receiver in which various aspects of indoor to outdoor wireless power delivery can be implemented.

FIG. 3 illustrates an example cross-sectional view of the transmitter and the receiver in which various aspects of indoor to outdoor wireless power delivery can be implemented.

FIG. 4 illustrates example views of a transmitter coil which can be used to implement various aspects of indoor to outdoor wireless power delivery.

FIG. 5 illustrates example views of a receiver coil which can be used to implement various aspects of indoor to outdoor wireless power delivery.

FIG. 6 illustrates an example system in which various aspects of indoor to outdoor wireless power delivery can be implemented.

FIG. 7 illustrates an example of the transmitter which can be used to implement various aspects of indoor to outdoor wireless power delivery.

FIGS. 8a and 8b illustrate example rectifier circuits of the receiver which can be used to implement various aspects of indoor to outdoor wireless power delivery.

FIG. 9 illustrates an example of efficiency versus delivered power in accordance with aspects of indoor to outdoor wireless power delivery.

FIG. 10 illustrates an example method of the indoor to outdoor wireless power delivery as generally related to configuring and generating wireless power delivery with the system 600 in the example environment 100 in accordance with aspects of the techniques described herein.

FIG. 11 illustrates another example method of the indoor to outdoor wireless power delivery as generally related to alignment of the transmitter and the receiver in accordance with aspects of the techniques described herein.

FIG. 12 illustrates an example environment in which indoor to outdoor wireless power delivery can be implemented in accordance with aspects of the techniques described herein.

FIG. 13 illustrates an example smart-home network device that can be implemented in a smart-home environment in accordance with one or more aspects of the techniques described herein.

FIG. 14 illustrates an example system with an example device that can implement aspects of indoor to outdoor wireless power delivery.

### DETAILED DESCRIPTION

Conventional techniques for connecting outdoor devices to power include determining suitable routing of cables from indoor power sources to outdoor locations, drilling holes through the structure for the cables, suitably installing the cables to avoid water penetration into the structure (e.g., forming cable drip loops), and weatherproofing the holes in the structure. Conventional installations may require skills an end user lacks, or if installed by a professional contractor, may increase the cost of deploying a smart home system.

Conventional techniques for inductive or wireless power transfer are generally optimized for charging batteries in mobile devices, such as placing a mobile phone on a charging mat. These techniques are designed for discontinuous power transfer across small distances, such as a few millimeters through the case of a cell phone and for the length of time required to charge a battery. These techniques are not effective for continuous power transfer across distances for the transfer of power through a building structure.

In aspects of indoor to outdoor wireless power delivery, a power transfer device includes a transmitter and a receiver. The transmitter is designed for use in an indoor environment while continuously providing power to the receiver for an outdoor device. The transmitter is designed to provide continuous power without the housing of the transmitter becoming hot, to the point of injuring a user or degrading any adhesive that mounts the transmitter to the building structure. The receiver is designed for continuous operation in an outdoor environment, where the receiver is exposed to outdoor temperatures, sunlight and ultraviolet (UV) radiation, precipitation, wind, dust, and so forth. Due to the different operating environments of the transmitter and the receiver, the design and materials of the transmitter and receiver may vary accordingly to ensure proper operation in their respective environments. For example, the plastic for the housing of the receiver may be selected for UV-resistance to prevent discoloring or degradation of the receiver housing, while the plastic for the transmitter housing may be selected for different qualities, such as esthetics, cost, and so forth. Electrical components may be selected based on the characteristics of the environments, such as selecting industrial grade components for the outdoor environment and commercial grade components for the indoor environment. Sealing of the receiver is designed to protect the receiver electronics from environment conditions such as precipitation, dust, wind, or the like.

In other aspects of indoor to outdoor wireless power delivery, the transmitter and receiver are designed to simplify attachment and alignment for the user, while optimizing power transfer between the transmitter and receiver. The transmitter and receiver may be mounted in any suitable manner, such as using adhesive, double-sided adhesive tape, magnets, suction cups, and so forth. The transmitter and receiver may also be attached to an intermediate mounting film, such as a transparent plastic, which is adhered to the building structure before the transmitter and/or receiver is attached. The transmitter and/or receiver is then attached to the intermediate mounting film using any suitable connector, such as snaps and the like. In addition to being easy to attach for a user, the transmitter and/or receiver mounting is designed to be easy to remove for the user. For example, the size of a double-sided adhesive tape is selected to provide a secure mounting but is sized to allow the user to remove the transmitter and/or receiver by applying torque to the housing of the transmitter and/or receiver to twist the transmitter and/or receiver off the building surface.

In aspects, proper alignment of the transmitter and the receiver maximizes the power transferred to the receiver. When the transmitter and receiver are mounted using the intermediate mounting film, alignment marks and/or patterns may be printed on the intermediate mounting film as a visual alignment aid when attaching to a transparent building material, such as glass, or the alignment marks and/or patterns may be used as a reference when measuring from one or more edges of a portion of the building structure, such as edges of a door, the intersection of walls, and so forth. In the case of using magnets in the transmitter and receiver for attachment, the magnets are disposed inside the housings of the transmitter and receiver to provide correct alignment, as well as attachment.

In aspects, alignment feedback is provided to the user by the transmitter and/or receiver. The transmitter and/or receiver may provide a visual and/or audible indication to the user of a state of alignment between the transmitter and the receiver. For example, the transmitter and/or receiver may indicate that the transmitter and receiver are aligned, not aligned, and/or partially aligned. For example, the transmitter and/or receiver may include a light emitting diode that changes color to indicate the state of alignment. The transmitter and/or receiver may provide audible feedback, such as a change in volume and or pitch of an audible signal to indicate the state of alignment. The transmitter and/or receiver may be directly or indirectly in communication with an application on a device, such as a smartphone app, that provides feedback to the user regarding the state of alignment.

In aspects, the transmitter includes a transmitter coil for transmission of power across a power transfer path, and the receiver includes a receiver coil for reception of the power transmitted across the power transfer path. The transmitter coil and the receiver coil may be of the same design or differing designs based on the requirements of the operating environments of the transmitter and receiver, desired electrical and/or electromagnetic characteristics, power transfer efficiency, desired length of the power transfer path, and so forth. Each coil can be formed using any conductor, such as litz wire or magnet wire of any suitable diameter and length, comprising copper, a copper-alloy, and the like. The litz wire or magnet wire may be insulated using any suitable insulator, such as an enameled coating, a polymer film, polyvinyl formal, polyurethane, polyamide, polyester, polyester-polyimide, polyamide-polyimide, polyimide, fiberglass yarn with varnish, paper, aramid paper, polyester film, cotton, permeated cotton, polytetrafluoroethylene, silk, or any combination thereof. The transmitter coil and the receiver coil may comprise any suitable number of turns of the conductor, using any suitable length of conductor to provide a desired inductance value. The inductance values of the transmitter coil and the receiver coil may be identical, approximately similar, or different to provide optimum power transfer across the power transfer path. The transmitter coil and the receiver coil may be formed with similar or different outer and inner dimensions, similar or different numbers of turns of the conductor, and/or conductors of similar or different wire gauges. The transmitter coil and/or the receiver coil may be attached to any suitable backing material to provide mechanical support for the conductor of coil. For example, the transmitter coil and/or the receiver coil may be attached to a ferrite sheet to shield electronics associated with the transmitter coil and/or the receiver coil from the electromagnetic flux and or magnetic fields produced during wireless power transfer.

In aspects of indoor to outdoor wireless power delivery, the direction of electrical current flow through the transmitter coil is switched at a frequency to increase the length of the power transfer path. Conventional techniques, such as those used in wireless charging across small distances (e.g., a few millimeters), operate at a frequency of approximately 115 kHz. In aspects, the switching frequency of the direction of current flow through the transmitter coil is increased to the range of 150 to 250 kHz to increase the distance at which wireless power is delivered efficiently. By way of example, and not limitation, the switching frequency of the direction of current flow through the transmitter coil is approximately 200 kHz to efficiently transfer power over a distance of approximately 25.4 mm.

In aspects of indoor to outdoor wireless power delivery, the efficiency of the power transfer is optimized by varying the input voltage to the transmitter coil, at a constant phase shift, or varying the phase shift with a constant input voltage to the transmitter coil, based on the power that is required to be delivered to an end device. As discussed in greater detail below, the receiver provides control feedback to the transmitter. For example, the receiver provides the required power to transfer to the transmitter, such as required power based on sensed power consumption at the output of the receiver. The transmitter adjusts the voltage and/or phase shift provided to the transmitter coil to optimize the efficiency of the power transfer. By way of example, and not limitation, the transmitter provides the lowest voltage of a range of voltages to the transmitter coil to provide the required power.

In aspects of indoor to outdoor wireless power delivery, the transmitter and the receiver communicate to control the wireless power transfer, to negotiate the configuration of the power transfer to provide the desired voltage and power to the end device, to relay communications to and/or from the end device, and the like. For example, the transmitter and the receiver may communicate using any suitable wireless protocol, such as Wi-Fi, Bluetooth Low Energy (BLE), ZigBee, IEEE 802.15.4, or the like. Additionally, in-band communication or backscatter communication can be used for communication between the transmitter and receiver by modulating data on the electromagnetic power transfer field at the transmitter coil and/or the receiver coil. In an example, even though the transmitter coil and the receiver coil are not designed for operation at the radio frequencies associated with these protocols, the path length for the communication is short, and the transmitter coil and/or the receiver coil may be used as antennas for these communications. Optionally or additionally, the transmitter and/or the receiver may include an additional antenna for communications between the transmitter and the receiver.

In another aspect of indoor to outdoor wireless power delivery, the transmitter and/or receiver may monitor power consumption and/or communication with the end device to determine if tampering has occurred, such as cutting a cable from the receiver to the end device, unauthorized removal of the end device, and so forth. An indication of the tampering is transmitted by the receiver and/or transmitter to the user, via a smart-home network, security system network, or the like.

In another aspect of indoor to outdoor wireless power delivery, the transmitter and/or receiver may be used to extend wireless communication to the end device. For example, the propagation of Wi-Fi signals from a Wi-Fi router may be attenuated by the building structure. The transmitter or the receiver may include a Wi-Fi radio. The Wi-Fi radio is configured to relay Wi-Fi communications or extend the home Wi-Fi network to provide Wi-Fi communication to the end device. Alternately or additionally, the receiver may receive communication from the end device via a wired connection, such as video from an outdoor camera via a Universal Serial Bus (USB) connection, and transmit those signals using the Wi-Fi radio included in the receiver.

### Example Environment

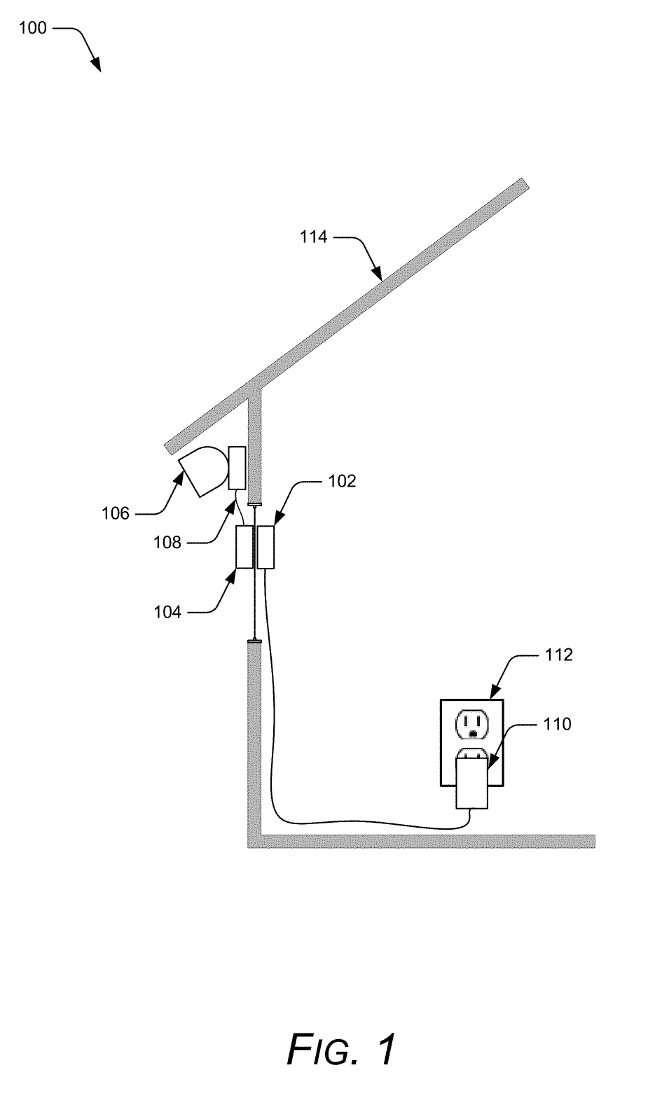

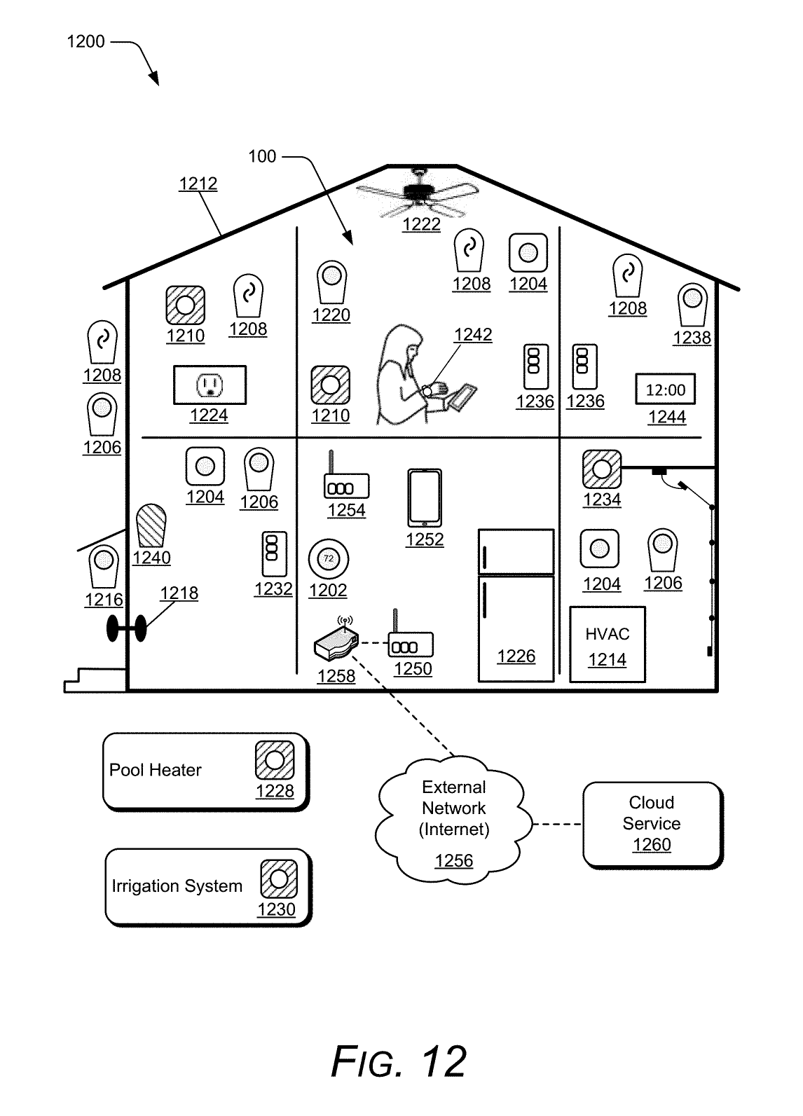

FIG. 1 illustrates an example environment 100 in which various aspects of indoor to outdoor wireless power delivery can be implemented. A transmitter 102 wirelessly provides power to a receiver 104. From the wirelessly received power, the receiver 104 provides power to an end device 106, via a cable 108. The end device 106 can be any device that is compatible with the power output delivered by the receiver 104, for example any device as described in reference to FIG. 12, below. Alternatively, or optionally, the receiver 104 and the end device 106 can be integrated into a single unit eliminating the need for the cable 108 or minimizing the length of the cable 108. The transmitter 102 receives power from a power supply 110, which is powered from mains power 112 of a structure 114. The transmitter 102 and the receiver 104 can be mounted on opposite sides of various elements of the structure 114, such as a window as shown in FIG. 1, a door, a wall, and so forth. The transmitter 102 and the receiver 104 can provide wireless power transfer through building materials, such as glass, wood, sheetrock, insulation, air gaps, a single-pane window, a double-pane window, a triple-pane window, a door, a wall, or any combination thereof.

### Example Devices

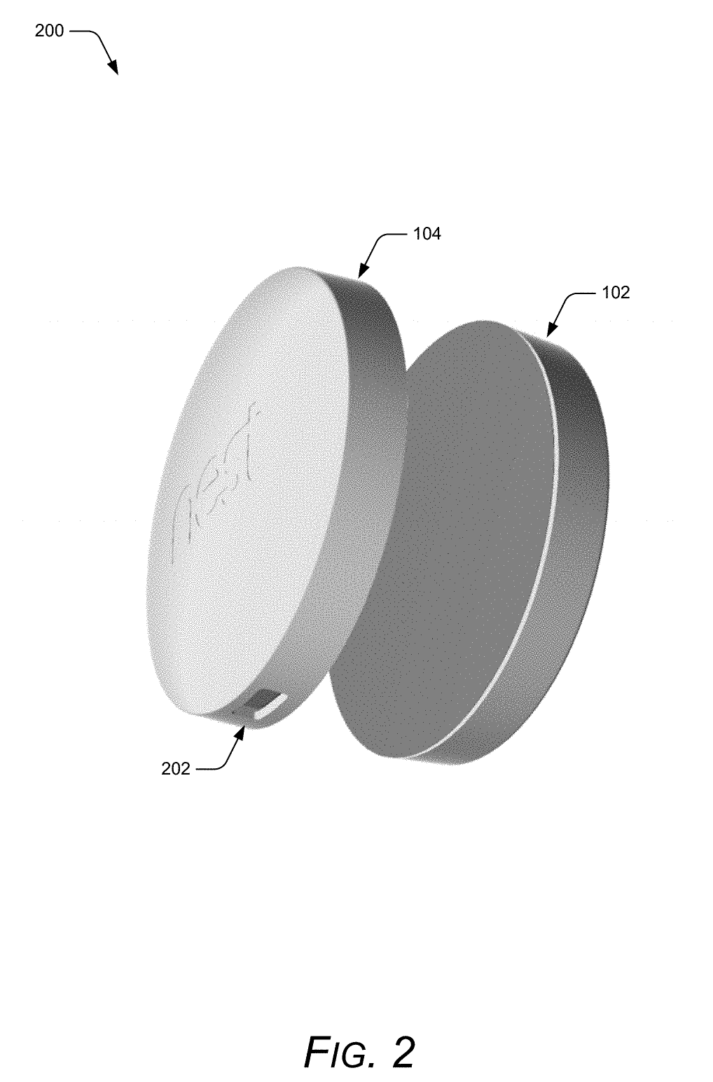

FIG. 2 illustrates, at 200, an example exterior view of the transmitter 102 and the receiver 104 in which various aspects of the indoor to outdoor wireless power delivery can be implemented. The transmitter 102 and receiver 104 as illustrated as being generally cylindrical in shape and approximately the same size; however, alternate shapes, such as oval, rectangular, rounded-rectangular, or round shapes, and differing sizes may be used. A connector 202 is illustrated on the receiver 104 to provide a connection to the end device 106 via the cable 108. Although the connector 202 is illustrated on the side of the receiver 104, the connector 202 may optionally located on the face of the receiver 104. The connector 202 may be any suitable type of connector, such as a Universal Serial Bus (USB) connector. The transmitter 102 also includes a connector 202 (not illustrated in FIG. 2) that may be located on the side or face of the transmitter 102. Optionally or alternatively, the connector 202 may be replaced with a captive cable attached to the transmitter 102 and/or the receiver 104.

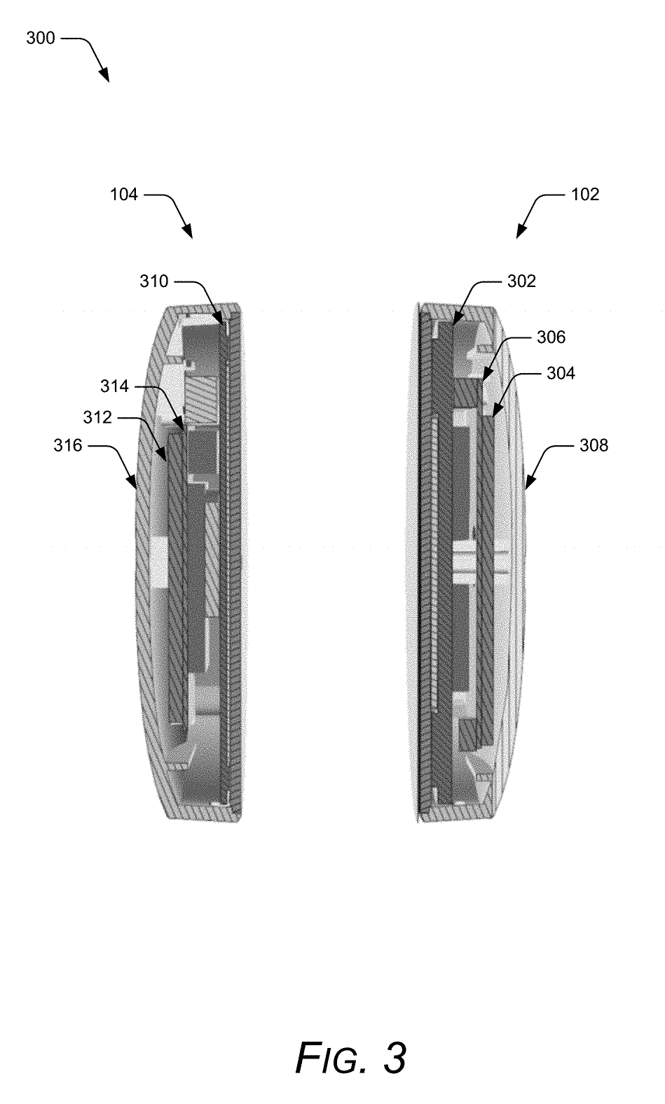

FIG. 3 illustrates, at 300, an example cross-sectional view of the transmitter 102 and the receiver 104 in which various aspects of indoor to outdoor wireless power delivery can be implemented. The transmitter 102 includes a transmitter coil 302 assembly that is electrically connected to a transmitter electronics 304 assembly. A ferrite shield 306 reduces coupling of magnetic fields produced by the transmitter coil 302 into the circuitry of the transmitter electronics 304. The transmitter 102 also comprises a transmitter housing 308. The transmitter coil 302 is placed close to the mounting surface of the transmitter housing 308 to reduce the distance over which power is transferred.

The receiver 104 includes a receiver coil 310 assembly that is electrically connected to a receiver electronics 312 assembly. A ferrite shield 314 reduces coupling of magnetic fields produced by the transmitter into the circuitry of the receiver electronics 312. The receiver 104 also comprises a receiver housing 316. The receiver coil 310 is displaced close to the mounting surface of the receiver housing 316 to reduce the distance over which power is transferred. The receiver housing 316 is resistant to outdoor environmental elements, such as precipitation, dust, wind, sunlight, and so forth.

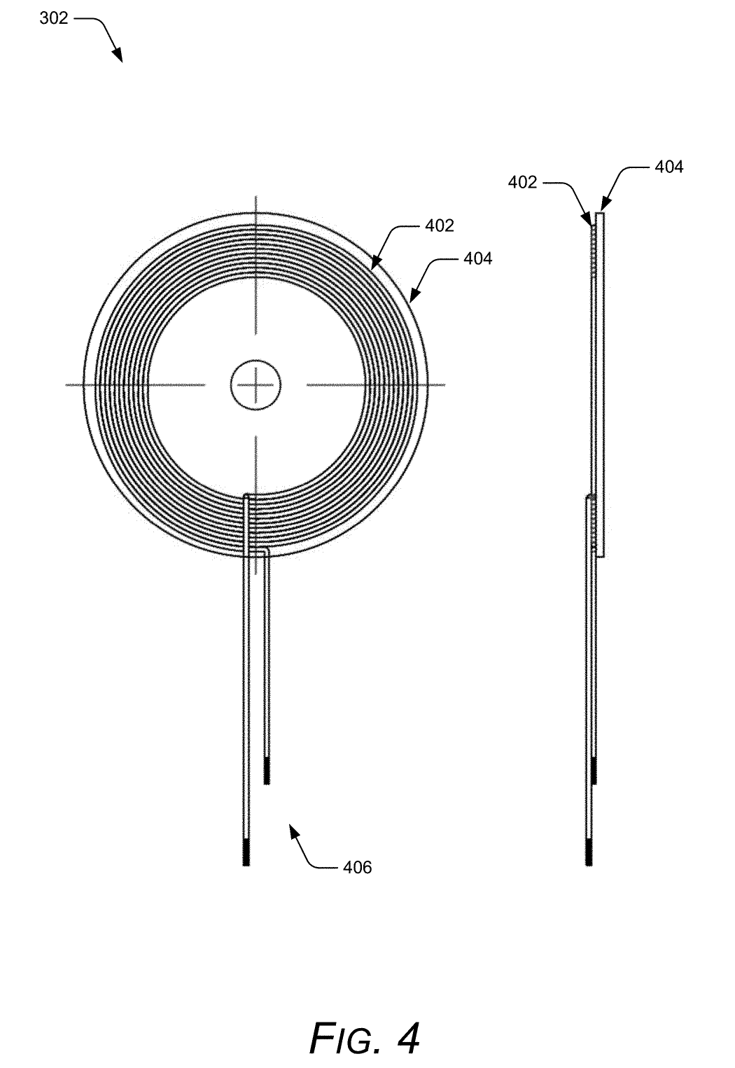

FIG. 4 illustrates example views of the transmitter coil 302 which can be used to implement various aspects of indoor to outdoor wireless power delivery. The transmitter coil 302 comprises multiple turns of litz wire or magnet wire that are generally wound as a planar spiral, shown at 402. The turns of litz wire or magnet wire are disposed toward the outside of the transmitter housing 308 to increase the distance over which power is transferred. The turns of litz wire or magnet wire are attached to a backing 404 in any suitable manner, such as double-sided adhesive film, epoxy, glue, or the like. The backing 404 may be composed of any suitable material. Optionally or additionally, the backing 404 may include ferrite material to shield the transmitter electronics 304 from the magnetic fields produced by the transmitter coil 302. The transmitter coil 302 is connected to the transmitter electronics 304 using the wire leads shown at 406. The shape of the transmitter coil 302 may be any suitable shape, such as circular, oval, rounded-rectangular, rectangular, or square.

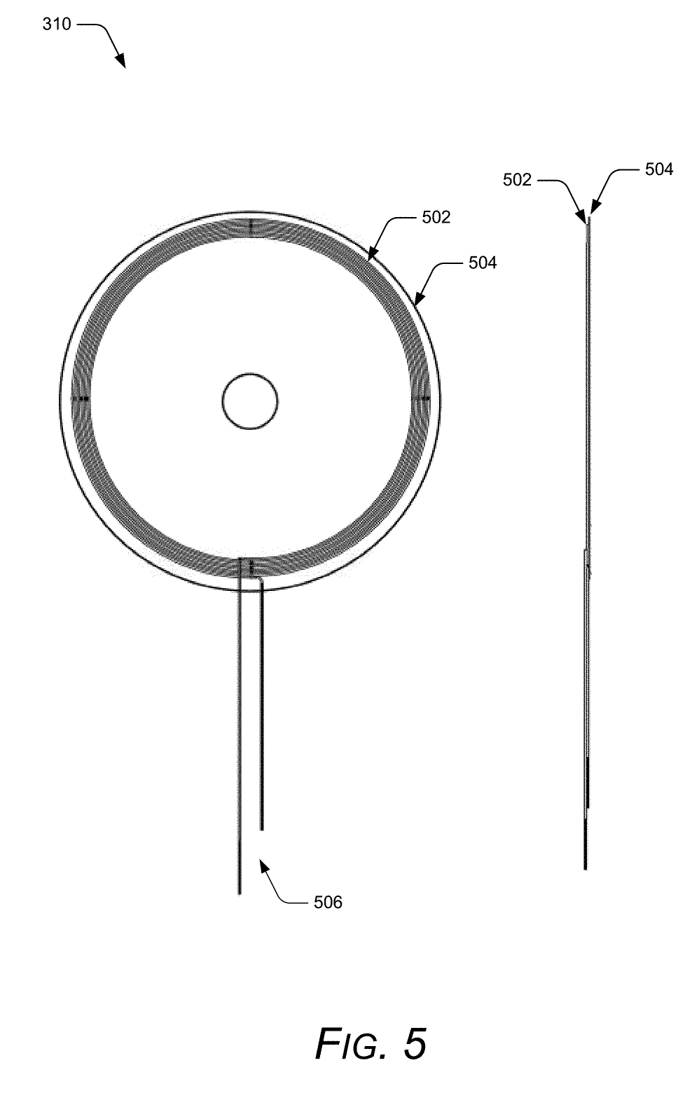

FIG. 5 illustrates example views of the receiver coil 310 which can be used to implement various aspects of indoor to outdoor wireless power delivery. The receiver coil 310 comprises multiple turns of litz wire or magnet wire that are generally wound as a planar spiral, shown at 502. The turns of litz wire or magnet wire are disposed toward the outside of the receiver housing 316 to increase the distance over which power is transferred. The turns of litz wire or magnet wire are attached to a backing 504 in any suitable manner, such as double-sided adhesive film, epoxy, glue, or the like. The backing 504 may be composed of any suitable material. Optionally or additionally, the backing 504 may include ferrite material to shield the receiver electronics 312 from the magnetic fields produced by the transmitter coil 302. The receiver coil 310 is connected to the receiver electronics 312 using the wire leads shown at 506. The shape of the receiver coil 310 may be any suitable shape, such as circular, oval, rounded-rectangular, rectangular, or square.

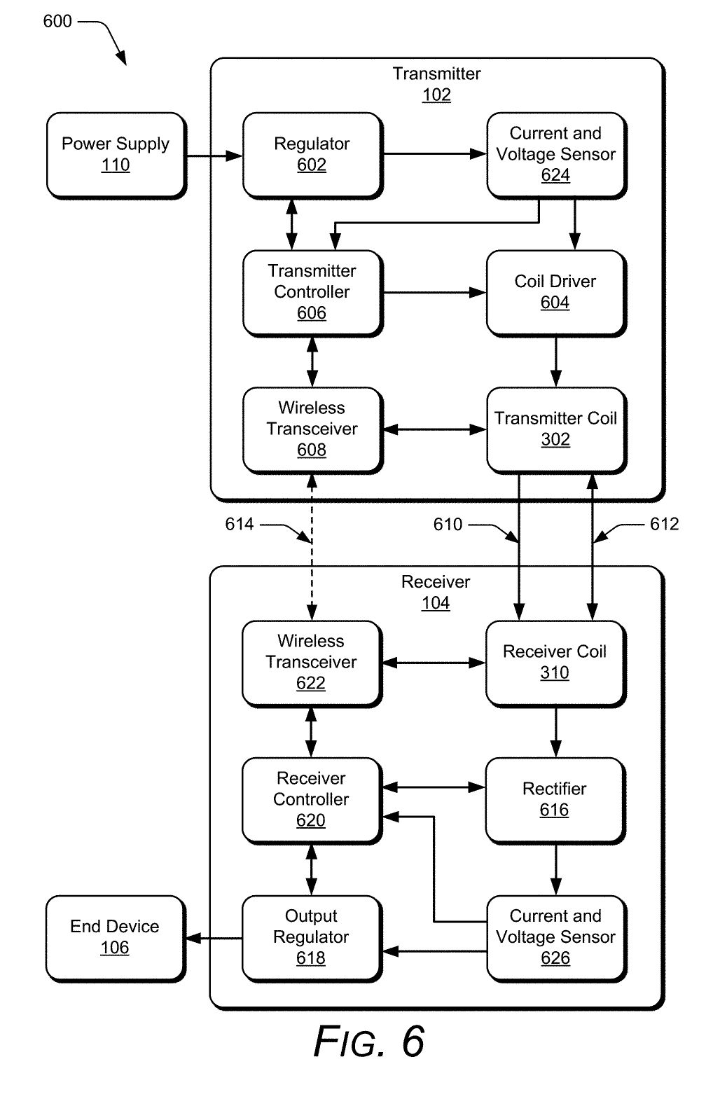

FIG. 6 illustrates an example system 600 in which various aspects of indoor to outdoor wireless power delivery can be implemented. The system 600 further illustrates features of the transmitter 102 and the receiver 104. The power supply 110 provides power to the transmitter 102. In aspects, the power supply 110 may provide power at a fixed voltage (e.g., five volts DC) and a fixed maximum current (e.g., two amperes). Additionally or optionally, the power supply 110 may be capable of providing power at various voltages and/or currents based on a negotiation protocol between the transmitter 102 and the power supply 110, such as USB-C power delivery.

The transmitter electronics 304 comprises a regulator 602, a coil driver 604, a transmitter controller 606, and a wireless transceiver 608. The regulator 602 is controlled by the transmitter controller 606 to adjust the voltage applied to the transmitter coil 302. The transmitter controller 606 adjusts the applied voltage to optimize the efficiency of the power transfer based on the power required by the end device 106. The required power for the end device 106 may be determined in any suitable manner, such as receiving a current value from a current sensing circuit in the receiver 104, a power requirement communicated from the end device 106, and so forth. The regulator 602 is configured to increase and/or decrease the voltage supplied by the power supply 110 to provide the desired voltage to the transmitter coil 302.

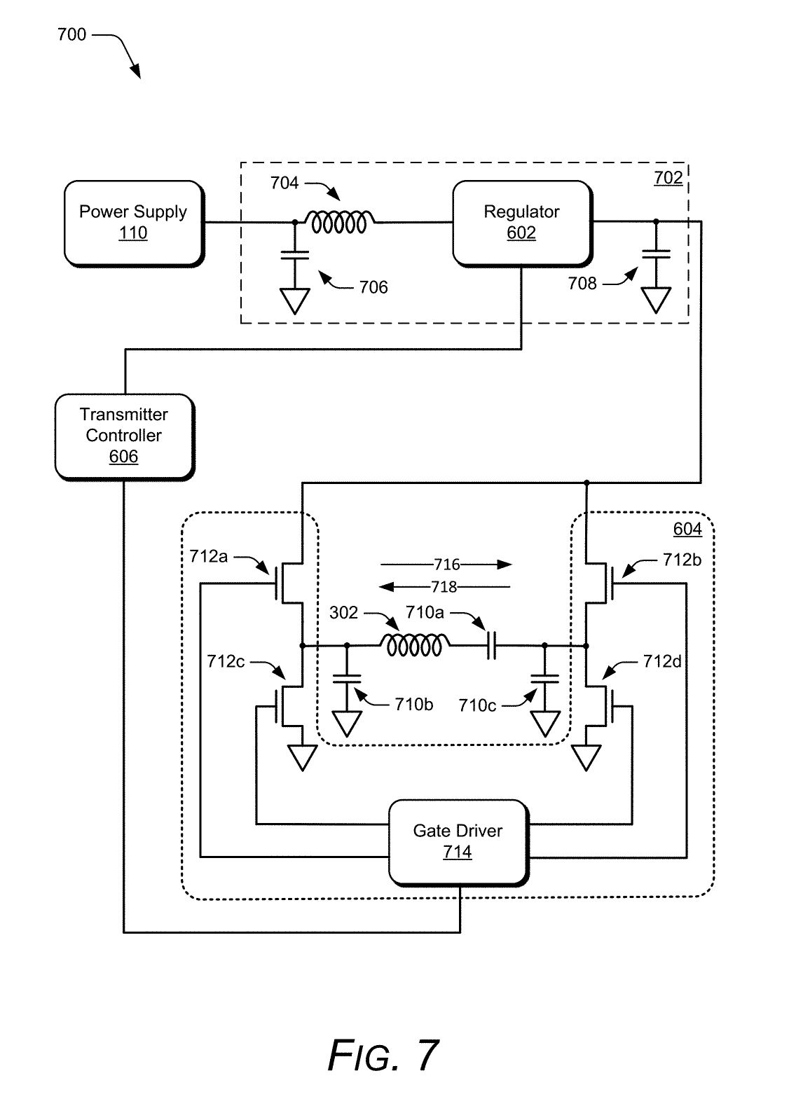

The coil driver 604 is a switching circuit (described in detail below, with respect to FIG. 7) that applies the output from the regulator 602 to the transmitter coil 302. The coil driver 604 switches the direction of the current flow through the transmitter coil 302 to produce an alternating magnetic and/or electromagnetic field to transfer power, shown at 610, to the receiver 104. The transmitter controller 606 controls the switching frequency, duty cycle, and/or switching phase to optimize the efficiency of the wireless power transfer. By way of example and not limitation, the switching rate of the coil driver 604 may be set to approximately 200 kHz to optimize power transfer across a distance of 25.4 mm.

The transmitter controller 606 communicates with the receiver 104 using the wireless transceiver 608. The wireless transceiver 608 transmits and/or receives via the transmitter coil 302, shown at 612, or using a separate antenna as shown at 614 (the separate antenna is not shown in FIG. 6 for the sake of clarity). Communication between the transmitter 102 and the receiver 104 may be unidirectional or bidirectional. The communication may include control settings, sensor readings, and/or data to or from the end device 106.

The receiver electronics 312 comprises a rectifier 616, an output regulator 618, a receiver controller 620, and a wireless transceiver 622. The output of the receiver coil 310 is connected to the rectifier 616 that converts the alternating current (AC) output of the receiver coil 310 to direct current (DC). The rectifier 616 may include additional components for filtering the rectified voltage, sensing current draw, and the like. The output of the rectifier 616 is connected to the output regulator 618 that converts the voltage received from the rectifier 616 to a desired voltage for the end device 106. The receiver controller 620 controls the output regulator 618 to adjust the output voltage of the receiver 104 to the desired voltage, depending on the requirements of the end device 106. Any suitable technique may be used to determine the requirements of the end device 106 and to adjust of the output voltage, such as USB-C Power Delivery, and the like.

The receiver controller 620 communicates with the transmitter 102 using the wireless transceiver 622. The wireless transceiver 622 transmits and/or receives via the receiver coil 310, shown at 612 or using a separate antenna as shown at 614 (the separate antenna is not shown in FIG. 6 for the sake of clarity). The receiver controller 620 may receive a current sense signal from the rectifier 616 and communicate the sensed current to the transmitter 102 to enable the transmitter to optimize the efficiency of the power transfer.

The transmitter 102 includes a current and voltage sensor 624 that monitors current flow from the regulator 602, input and output voltages, and voltage and zero-crossings across the transmitter coil 302. The receiver 104 includes a current and voltage sensor 626 that monitors current flow, input and output voltages, and voltage and zero-crossings across the receiver coil 310 and/or the rectifier 616.

FIG. 7 illustrates, at 700, an example of the transmitter 102 which can be used to implement various aspects of indoor to outdoor wireless power delivery. In aspects, the transmitter 102 includes a voltage converter shown at 702, such as boost converter, a buck converter, or a buck/boost converter. By way of example, and not limitation, the voltage converter, shown at 702, includes a series inductor 704 that is connected between the power supply 110 and the regulator 602, an input capacitor 706 connected between the input of the series inductor 704 and ground, and an output capacitor 708 is connected between the output of the voltage regulator 602 and ground. In other aspects, the voltage converter 702 may be implemented by connecting the output of the inductor 704 to the node connecting FET 712a and FET 712c (or alternatively FET 712b and FET 712d) to use the pair of FETs 712 as part of the boost converter. Optionally or additionally, a current senor (not shown in FIG. 7 for the sake of clarity) is connected between the power supply 110 and the voltage converter 702 to monitor the current flow from the power supply 110 to the downstream circuitry for control and feedback of functions in the transmitter 102, the receiver 104 and/or the power supply 110.

One or more tuning capacitors 710 and the transmitter coil 302 form a resonant circuit. For example, a tuning capacitor 710a is connected in series with the transmitter coil 302. Alternatively or additionally, tuning capacitors 710b and 710c are connected from either end of the series combination of the transmitter coil 302 and the tuning capacitor 710a to ground. The value of the tuning capacitors 710 are selected to form a resonant circuit with the transmitter coil 302 at a desired frequency of operation for the transmitter 102. The capacitance value of the tuning capacitors 710 and the inductance value of the transmitter coil 302 are selected to resonate at a frequency to provide the desired distance for the wireless power transfer. The capacitance values of the tuning capacitors 710 may be the same value or different values.

The coil driver 604 includes field effect transistors (FETs) 712 (illustrated as FETs 712a-712d) and a gate driver 714 circuit to control the operation of the FETs 712. The transmitter controller 606 configures the gate driver 714 to switch pairs of the FETs 712 to an on-state to conduct current through the transmitter coil 302 in alternating directions. The transmitter controller 606 configures parameters related to switching the FETs 712, including switching frequency, switching phase, switching duty cycle, and so forth. Optionally or additionally, the transmitter controller 606 configures the output voltage of the regulator 602 based on parameters including the power required for the end device 106, the distance of the wireless power transfer, and so forth.

To produce the alternating electromagnetic field for the wireless power transfer, the gate driver 714 alternatively turns pairs of the FETs 712 on and off to alternate current flow through the transmitter coil 302. For example, the gate driver 714 first switches the FETs 712a and 712d to the on-state to flow the output current of the regulator 602 through the FET 712a, the transmitter coil 302, and the FET 712d in the direction shown at 716, while the FETs 712b and 712c are in an off-state. Next the gate driver 714 switches the FETs 712b and 712c to the on-state to flow the output current of the regulator 602 through the FET 712b, the transmitter coil 302, and the FET 712c in the direction shown at 718, while the FETs 712a and 712d are in the off-state. Additionally and/or optionally, to increase component life, reduce power dissipation, and/or reduce the generation of electromagnetic interference (EMI), the switching of the FETs 712 may include dead times when none of the FETs 712 are switched on, each FET 712 in a pair of FETs 712 may be sequentially turned on, and so forth.

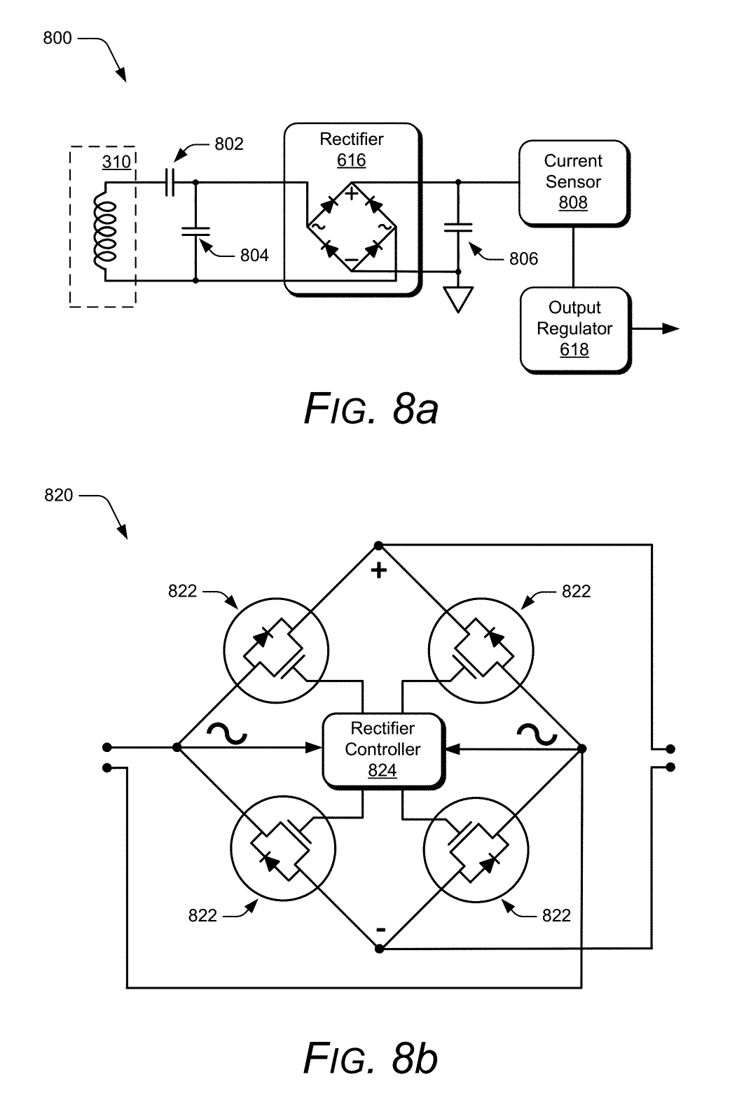

FIGS. 8a and 8b illustrate example rectifier circuits of the receiver 104 that can be used to implement various aspects of indoor to outdoor wireless power delivery. FIG. 8a illustrates, at 800, the connection of the rectifier 616 to other circuitry in the receiver 104. The wireless transfer of power is received by the resonant circuit formed by the receiver coil 310, a capacitor 802, and a capacitor 804. The AC voltage across the capacitor 804 is applied to the input of the rectifier 616, which as shown as a four-diode, full-wave bridge rectifier that converts the received AC voltage to a DC voltage, which is filtered by a capacitor 806. The current consumed by the end device 106 is measured by a current sensor 808. The sensed current is provided to the receiver controller 620 (not shown in FIG. 8a) which in turn may be transmitted to the transmitter 102 for use in controlling and/or optimizing the power transfer. Alternatively, the current sensor 808 may be located in other positions in the receiver 104, such as after the output regulator 618. Additionally and/or optionally the sensed current from the current sensor 808 may be monitored to detect tampering based on changes in current consumption from cutting the cable 108, removal of the end device 106, and so forth.

FIG. 8b illustrates, at 820, an alternative rectifier design to improve the efficiency of the rectifier 616. The diodes in the full-wave bridge rectifier illustrated in FIG. 8a, typically have a voltage drop of 0.7 volts. Thus, 1.4 volts is lost in the voltage drop across the two conducting diodes during each half-cycle of the AC waveform. In aspects, field effect transistors (FET) 822 replace the diodes in a full-wave bridge rectifier circuit. The gates of the FETs 822 are connected to a rectifier controller 824. The AC input to the rectifier is connected to the rectifier controller 824. The rectifier controller 824 tracks the AC input voltage and controls switching of the FETs 822 to rectify the AC input to produce a DC output. The voltage drop across the FETs 822 is approximately 0.02 volts, which is less than the 0.7 volt drop across the diodes shown in FIG. 8a and increases the efficiency of the rectifier 616. Alternatively and/or optionally multiple rectifier controllers 824 may be employed, such as one rectifier controller 824 connected to each of the FETs 822.

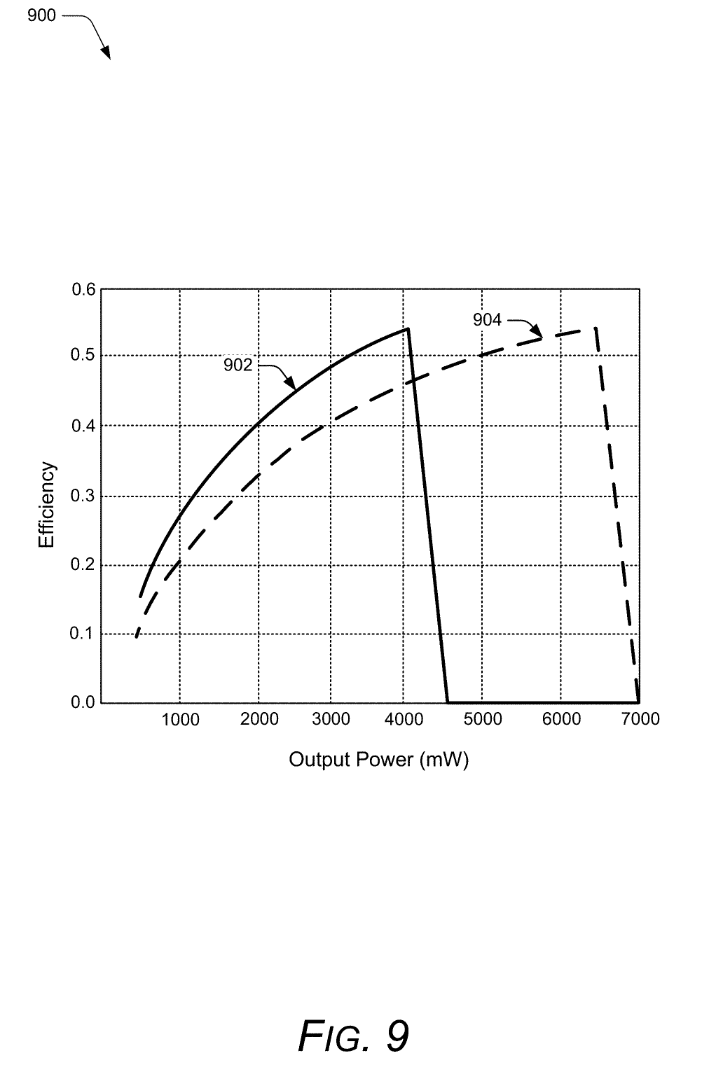

FIG. 9 illustrates, at 900, an example of efficiency versus delivered power in accordance with aspects of indoor to outdoor wireless power delivery. The efficiency of power delivery can depend on the voltage applied across the transmitter coil 302. For example, the curve 902 illustrates power efficiency at a lower voltage across the transmitter coil 302 than the voltage associated with the curve 904. Based on receiving the sensed current and/or power requirements of the end device 106 from the receiver 104, the transmitter controller 606 configures the regulator 602 and/or the coil driver 604 to apply a voltage level to the transmitter coil 302 to optimize the efficiency of the power transfer.

### Example Methods

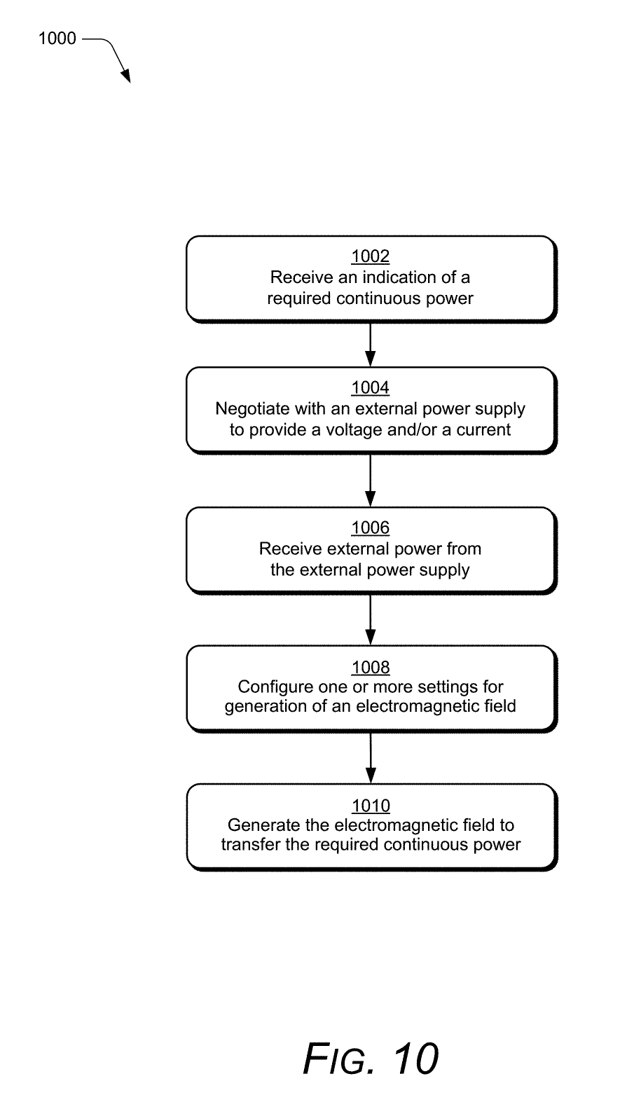

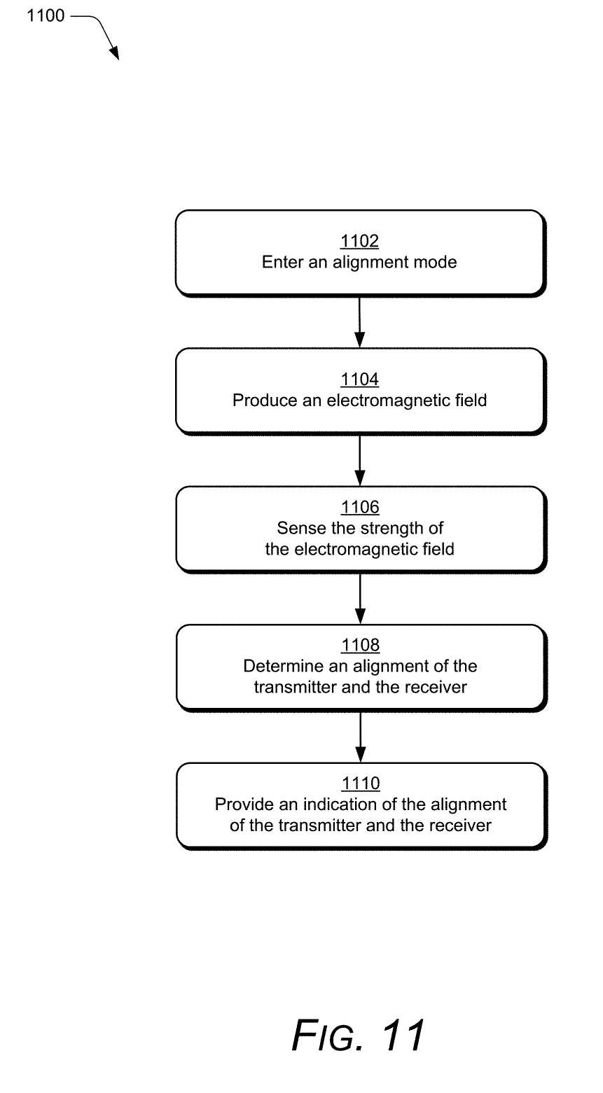

Example methods 1000 and 1100 are described with reference to respective FIGS. 10 and 11 in accordance with one or more aspects of the indoor to outdoor wireless power delivery. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 10 illustrates example method(s) 1000 of indoor to outdoor wireless power delivery as generally related to configuring and generating wireless power delivery with the system 600 in the example environment 100. The order in which the method blocks are described are not intended to be construed as a limitation, and any number of the described method blocks can be combined in any order to implement a method, or an alternate method.

At block 1002, a transmitter receives an indication of a required continuous power from a receiver. For example, the transmitter controller 606 in the transmitter 102 receives an indication of a required continuous power from the receiver controller 620 in the receiver 104.

At block 1004, the transmitter negotiates with an external power supply to provide a voltage and/or current to enable the transmitter to provide the required continuous power. For example, the transmitter controller 606 in the transmitter 102 negotiates with the power supply 110 to provide power at a voltage and/or current sufficient to enable the transmitter 102 to provide the required continuous power to the receiver 104.

At block 1006, the transmitter receives external power from the external power supply. For example, based on the negotiation, the transmitter 102 receives external power from the power supply 110.

At block 1008, the transmitter configures settings for the generation of an electromagnetic field to transfer power from the transmitter to the receiver. For example, the transmitter controller 606 configures the regulator 602 and the coil driver 604 to generate an electromagnetic field that provides the required continuous power.

At block 1010, the transmitter generates the electromagnetic field to transfer the required power to the receiver. For example, the regulator 602 provides power to the coil driver 604 that generates an alternating current through the transmitter coil 302 to produce the electromagnetic field for the power transfer.

FIG. 11 illustrates example method(s) 1100 of indoor to outdoor wireless power delivery as generally related to alignment of the transmitter 102 and the receiver 104. The order in which the method blocks are described are not intended to be construed as a limitation, and any number of the described method blocks can be combined in any order to implement a method, or an alternate method.

At block 1102, a wireless power transfer system enters an alignment mode. For example, the transmitter 102 and the receiver 104 enter an alignment mode.

At block 1104, the transmitter produces an electromagnetic field. For example, the transmitter 102 produces an electromagnetic field to transfer power to the receiver 104.

At block 1106, the receiver senses the strength of the electromagnetic field. For example, the receiver 104 senses the electromagnetic field using the receiver coil 310, the rectifier 616, the output regulator 618, and/or the current sensor 808.

At block 1108, the system determines an alignment of the transmitter and the receiver. For example, the receiver controller 620 determines an alignment of the transmitter 102 and the receiver 104, based on the sensed electromagnetic field.

At block 1110, the system provides an indication of the alignment of the transmitter and the receiver. For example, the receiver controller 620 provides an indication of the alignment based on the determined alignment of the transmitter 102 and the receiver 104.

### Example Application Environments

FIG. 12 illustrates an example environment 1200 in which aspects of indoor to outdoor wireless power delivery can be implemented. Generally, the environment 1200 includes the environment 100 implemented as part of a smart-home or other type of structure with any number of smart-home devices that are configured for communication in a smart-home network. For example, the smart-home devices can include a thermostat 1202, hazard detectors 1204 (e.g., for smoke and/or carbon monoxide), cameras 1206 (e.g., indoor and outdoor), lighting units 1208 (e.g., indoor and outdoor), and any other types of smart-home network devices 1210 that are implemented inside and/or outside of a structure 1212 (e.g., in a smart-home environment). In this example, the smart-home devices can also include other devices, such as a border router 1250, a leader device, a commissioning device 1252, a hub device 1254, as well as devices implemented as a router, and/or an end device.

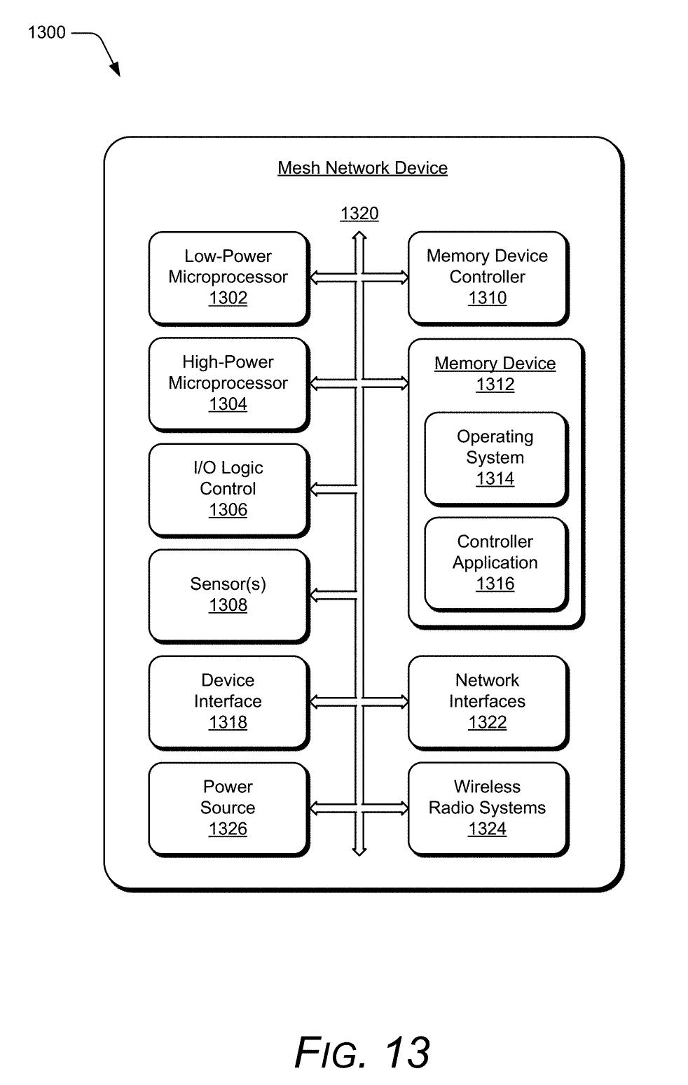

In the environment 1200, any number of the smart-home network devices can be implemented for wireless interconnection to wirelessly communicate and interact with each other. The smart-home network devices are modular, intelligent, multi-sensing, network-connected devices that can integrate seamlessly with each other and/or with a central server or a cloud-computing system to provide any of a variety of useful smart-home objectives and implementations. An example of a smart-home network device that can be implemented as any of the devices described herein is shown and described with reference to FIG. 13.

In implementations, the thermostat 1202 may include a Nest® Learning Thermostat that detects ambient climate characteristics (e.g., temperature and/or humidity) and controls a HVAC system 1214 in the smart-home environment. The learning thermostat 1202 and other smart devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 1204 can be implemented to detect the presence of a hazardous substance or a substance indicative of a hazardous substance (e.g., smoke, fire, or carbon monoxide). In examples of wireless interconnection, a hazard detector 1204 may detect the presence of smoke, indicating a fire in the structure, in which case the hazard detector that first detects the smoke can broadcast a low-power wake-up signal to all of the connected smart-home network devices. The other hazard detectors 1204 can then receive the broadcast wake-up signal and initiate a high-power state for hazard detection and to receive wireless communications of alert messages. Further, the lighting units 1208 can receive the broadcast wake-up signal and activate in the region of the detected hazard to illuminate and identify the problem area. In another example, the lighting units 1208 may activate in one illumination color to indicate a problem area or region in the structure, such as for a detected fire or break-in, and activate in a different illumination color to indicate safe regions and/or escape routes out of the structure.

In various configurations, the smart-home network devices 1210 can include an entryway interface device 1216 that functions in coordination with a network-connected door lock system 1218, and that detects and responds to a person's approach to or departure from a location, such as an outer door of the structure 1212. The entryway interface device 1216 can interact with the other smart-home network devices based on whether someone has approached or entered the smart-home environment. An entryway interface device 1216 can control doorbell functionality, announce the approach or departure of a person via audio or visual means, and control settings on a security system, such as to activate or deactivate the security system when occupants come and go.

In aspects, the entryway interface device 1216 is designed with two-part construction for mounting on a sidelight window pane adjacent to a door or a glass panel at a location suitable for doorbell use. The entryway interface device 1216 comprises an inside portion that couples to the inside of the glass, and an outside portion that couples to the outside of the glass. The outside and inside portions do not physically touch each other because the glass is disposed between them. The inside portion connects to a permanent, always-on power source, and includes a camera. The outside portion does not connect to any power source. The outside portion is positioned and configured relative to the inside portion such that the camera of the inside portion can view the doorway area through the window glass (i.e., the outside portion of the entryway interface device 1216 does not block the view of the camera).

In an example, the outside portion of the entryway interface device 1216 is unpowered and includes a mechanical button element that is pressed by the visitor. The button-press is communicated to the inside portion by vibration or mechanically induced sound, or by an unpowered energy-harvesting Radio Frequency (RF) switch, such as EnOcean™ energy-harvesting switch. In another example, the outside portion of the entryway interface device 1216 is battery-powered, and the button-press is communicated to the inside portion via wireless communication. Optionally or additionally, the battery can be rechargeable and be trickle-charged by a small solar cell built into the casing of the outside portion of the entryway interface device 1216. Optionally or additionally, there can be inductive power coupling through the window between the inside and outside portions that charges a rechargeable battery according to an energy buffering technique that charges the battery most of the time but uses the battery to make up any power deficits when needed during periods of high-power operation. The use of energy buffering enables the use of relatively high-powered night vision infrared (IR) illuminators in the outside portion of the entryway interface device 1216 to avoid reflection of the IR light off the window glass. Additionally or optionally, the outside portion of the entryway interface device 1216 includes a presence detector and a low-power microphone. The microphone is powered only when the presence detector detects a person is at the door.

In another example, the outdoor portion of the entryway interface system 1216 may be powered through a door or a wall, in addition to being powered through glass. In this example, the camera is included in the outdoor portion of the entryway interface system 1216.

The smart-home network devices 1210 can also include other sensors and detectors, such as to detect ambient lighting conditions, detect room-occupancy states (e.g., with an occupancy sensor 1220), and control a power and/or dim state of one or more lights. In some instances, the sensors and/or detectors may also control a power state or speed of a fan, such as a ceiling fan 1222. Further, the sensors and/or detectors may detect occupancy in a room or enclosure, and control the supply of power to electrical outlets or devices 1224, such as if a room or the structure is unoccupied.

The smart-home network devices 1210 may also include connected appliances and/or controlled systems 1226, such as refrigerators, stoves and ovens, washers, dryers, air conditioners, pool heaters 1228, irrigation systems 1230, security systems 1232, and so forth, as well as other electronic and computing devices, such as televisions, entertainment systems, computers, intercom systems, garage-door openers 1234, ceiling fans 1222, control panels 1236, and the like. When plugged in, an appliance, device, or system can announce itself to the smart-home network as described above, and can be automatically integrated with the controls and devices of the smart-home network, such as in the smart-home. It should be noted that the smart-home network devices 1210 may include devices physically located outside of the structure, but within wireless communication range, such as a device controlling a swimming pool heater 1228 or an irrigation system 1230.

The smart-home network includes a border router 1250 that interfaces for communication with an external network 1256, outside the smart-home network. The border router 1250 connects to an access point 1258, which connects to the external communication network 1256, such as the Internet. A cloud service 1260, which is connected via the external communication network 1256, provides services related to and/or using the devices within the smart-home network. By way of example, the cloud service 1260 can include applications for the commissioning device 1252, such as smart phones, tablets, and the like, to devices in the smart-home network, processing and presenting data acquired in the smart-home network to end users, linking devices in one or more smart-home networks to user accounts of the cloud service 1260, provisioning and updating devices in the smart-home network, and so forth. For example, a user can control the thermostat 1202 and other smart-home network devices in the smart-home environment using a network-connected computer or portable device, such as a mobile phone or tablet device. Further, the smart-home network devices can communicate information to any central server or cloud-computing system via the border router 1250 and the access point 1258. The data communications can be carried out using any of a variety of custom or standard wireless protocols (e.g., Wi-Fi, ZigBee for low power, 6LoWPAN, Bluetooth Low Energy, etc.) and/or by using any of a variety of custom or standard wired protocols (CAT6 Ethernet, HomePlug, etc.).

Any of the smart-home network devices in the smart-home network can serve as low-power and communication nodes to create the smart-home network in the smart-home environment. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the smart-home network. The smart-home network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light, and activate the light source when the ambient light sensor 1238 detects that the room is dark and when the occupancy sensor 1220 detects that someone is in the room. Further, the sensor can include a low-power wireless communication chip (e.g., a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the smart-home network, from node to node (i.e., smart device to smart device) within the smart-home environment as well as over the Internet to a central server or cloud-computing system.

In other configurations, various ones of the smart-home network devices can function as “tripwires” for a security system in the smart-home environment. For example, in the event a perpetrator circumvents detection by security sensors 1240 located at windows, doors, and other entry points of the structure or environment, an alarm could still be triggered by receiving an occupancy, motion, heat, sound, etc. message from one or more of the low-powered smart-home nodes in the smart-home network. In other implementations, the smart-home network can be used to automatically turn on and off the lighting units 1208 as a person transitions from room to room in the structure. For example, the smart-home network devices can detect the person's movement through the structure and communicate corresponding messages via the nodes of the smart-home network. Using the messages that indicate which rooms are occupied, other smart-home network devices that receive the messages can activate and/or deactivate accordingly. As referred to above, the smart-home network can also be utilized to provide exit lighting in the event of an emergency, such as by turning on the appropriate lighting units 1208 that lead to a safe exit. The light units 1208 may also be turned-on to indicate the direction along an exit route that a person should travel to safely exit the structure.

The various smart-home network devices may also be implemented to integrate and communicate with wearable computing devices 1242, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other smart-home network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the smart-home network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a smart-home node device on the smart-home network, conforming to the wireless interconnection protocols for communicating on the smart-home network.

The smart-home network devices 1210 may also include a smart alarm clock 1244 for each of the individual occupants of the structure in the smart-home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the smart-home network based on a unique signature of the person, which is determined based on data obtained from sensors located in the smart-home network devices, such as sensors that include ultrasonic sensors, passive IR sensors, and the like. The unique signature of an occupant can be based on a combination of patterns of movement, voice, height, size, etc., as well as using facial recognition techniques.

In an example of wireless interconnection, the wake time for an individual can be associated with the thermostat 1202 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other smart-home network devices can use the data to provide other smart-home objectives, such as adjusting the thermostat 1202 so as to pre-heat or cool the environment to a desired setting, and turning-on or turning-off the lights 1208.

In implementations, the smart-home network devices can also be utilized for sound, vibration, and/or motion sensing such as to detect running water and determine inferences about water usage in a smart-home environment based on algorithms and mapping of the water usage and consumption. This can be used to determine a signature or fingerprint of each water source in the home, and is also referred to as “audio fingerprinting water usage.” Similarly, the smart-home network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

FIG. 13 illustrates an example smart-home network device 1300 that can be implemented in accordance with one or more aspects of the indoor to outdoor wireless power delivery as described herein. The device 1300 can be integrated with electronic circuitry, microprocessors, memory, input output (I/O) logic control, communication interfaces and components, as well as other hardware, firmware, and/or software to implement the device in a smart-home network. Further, the smart-home network device 1300 can be implemented with various components, such as with any number and combination of different components as further described with reference to the example device shown in FIG. 13.

In this example, the smart-home network device 1300 includes a low-power microprocessor 1302 and a high-power microprocessor 1304 (e.g., microcontrollers or digital signal processors) that process executable instructions. The device also includes an input-output (I/O) logic control 1306 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 1302 and the high-power microprocessor 1304 can also support one or more different device functionalities of the device. For example, the high-power microprocessor 1304 may execute computationally intensive operations, whereas the low-power microprocessor 1302 may manage less complex processes such as detecting a hazard or temperature from one or more sensors 1308. The low-power processor 1302 may also wake or initialize the high-power processor 1304 for computationally intensive processes.

The one or more sensors 1308 can be implemented to detect various properties and/or environmental conditions such as acceleration, temperature, humidity, water, supplied power, proximity, external motion, device motion, sound signals, ultrasound signals, light signals, fire, smoke, carbon monoxide, global-positioning-satellite (GPS) signals, radio-frequency (RF), other electromagnetic signals or fields, or the like. As such, the sensors 1308 may include any one or a combination of temperature sensors, humidity sensors, hazard-related sensors, security sensors, other environmental sensors, accelerometers, microphones, optical sensors up to and including cameras (e.g., charged coupled-device or video cameras, active or passive radiation sensors, GPS receivers, and radio frequency identification detectors. In implementations, the smart-home network device 1300 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or smart-operation objectives.

The smart-home network device 1300 includes a memory device controller 1310 and a memory device 1312, such as any type of a nonvolatile memory and/or other suitable electronic data storage device. The smart-home network device 1300 can also include various firmware and/or software, such as an operating system 1314 that is maintained as computer executable instructions by the memory and executed by a microprocessor. The device software may also include a controller application 1316 that implements aspects of the indoor to outdoor wireless power delivery. The smart-home network device 1300 also includes a device interface 1318 to interface with another device or peripheral component, and includes an integrated data bus 1320 that couples the various components of the smart-home network device for data communication between the components. The data bus in the smart-home network device may also be implemented as any one or a combination of different bus structures and/or bus architectures.

The device interface 1318 may receive input from a user and/or provide information to the user (e.g., as a user interface), and a received input can be used to determine a setting. The device interface 1318 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 1318 may also receive inputs from any number of peripherals, such as buttons, a keypad, a switch, a microphone, and an imager (e.g., a camera device).

The smart-home network device 1300 can include network interfaces 1322, such as a mesh network interface for communication with other smart-home network devices in a smart-home network, and an external network interface for network communication, such as via the Internet. The smart-home network device 1300 also includes wireless radio systems 1324 for wireless communication with other smart-home network devices via the mesh network interface and for multiple, different wireless communications systems. The wireless radio systems 1324 may include Wi-Fi, Bluetooth™, Mobile Broadband, Bluetooth Low Energy (BLE), and/or point-to-point IEEE 802.15.4. Each of the different radio systems can include a radio device, antenna, and chipset that is implemented for a particular wireless communications technology. The smart-home network device 1300 also includes a power source 1326, such as a battery, to connect the device to line voltage, and/or to connect to the receiver 104. An AC power source may also be used to charge the battery of the device.

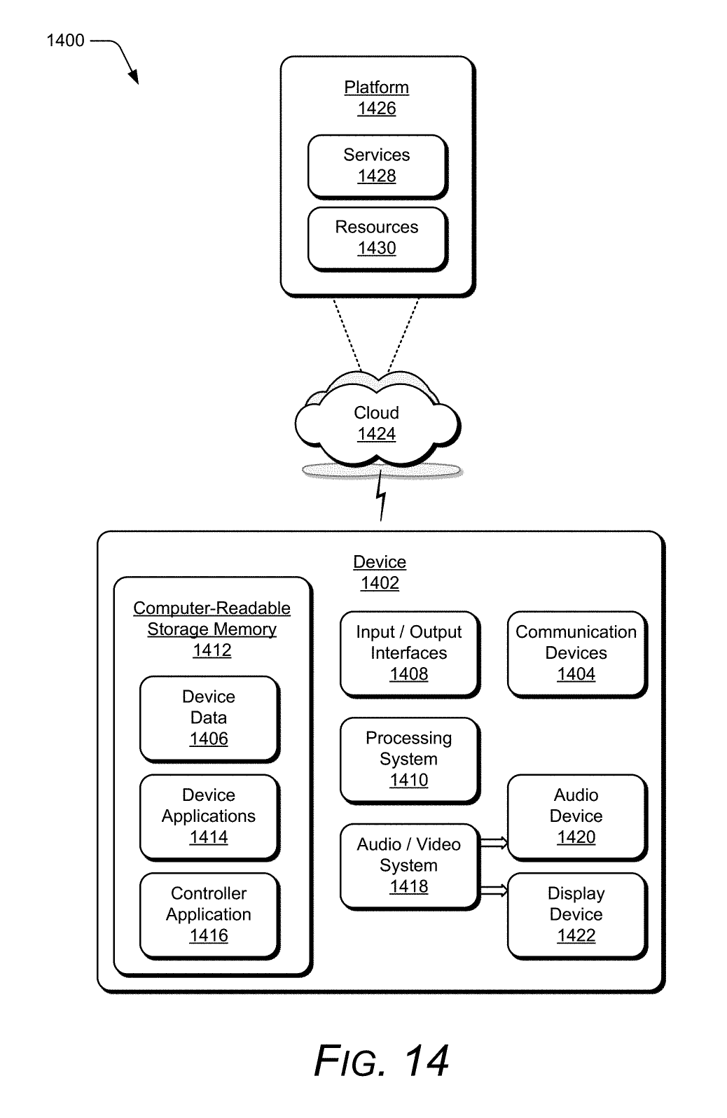

FIG. 14 illustrates an example system 1400 that includes an example device 1402, which can be implemented as any of the smart-home network devices that implement aspects of the indoor to outdoor wireless power delivery as described with reference to the previous FIGS. 1-13. The example device 1402 may be any type of computing device, client device, mobile phone, tablet, communication, entertainment, gaming, media playback, and/or other type of device. Further, the example device 1402 may be implemented as any other type of smart-home network device that is configured for communication on a smart-home network, such as a thermostat, hazard detector, camera, light unit, commissioning device, router, border router, joiner router, joining device, end device, leader, access point, a hub, and/or other smart-home network devices.

The device 1402 includes communication devices 1404 that enable wired and/or wireless communication of device data 1406, such as data that is communicated between the devices in a smart-home network, data that is being received, data scheduled for broadcast, data packets of the data, data that is synched between the devices, etc. The device data can include any type of communication data, as well as audio, video, and/or image data that is generated by applications executing on the device. The communication devices 1404 can also include transceivers for cellular phone communication and/or for network data communication.

The device 1402 also includes input/output (I/O) interfaces 1408, such as data network interfaces that provide connection and/or communication links between the device, data networks (e.g., a mesh network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 1402 includes a processing system 1410 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1402 may further include any type of a system bus or other data and command transfer system that couples the various components within the device. A system bus can include any one or combination of different bus structures and architectures, as well as control and data lines.

The device 1402 also includes computer-readable storage memory 1412, such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 1412 provides storage of the device data 1406 and various device applications 1414, such as an operating system that is maintained as a software application with the computer-readable storage memory and executed by the processing system 1410. The device applications may also include a device manager, such as any form of a control application, software application, signal processing and control module, code that is native to a particular device, a hardware abstraction layer for a particular device, and so on. In this example, the device applications also include a controller application 1416 that implements aspects of the indoor to outdoor wireless power delivery, such as when the example device 1402 is implemented as any of the smart-home network devices described herein.

The device 1402 also includes an audio and/or video system 1418 that generates audio data for an audio device 1420 and/or generates display data for a display device 1422. The audio device and/or the display device include any devices that process, display, and/or otherwise render audio, video, display, and/or image data, such as the image content of a digital photo. In implementations, the audio device and/or the display device are integrated components of the example device 1402. Alternatively, the audio device and/or the display device are external, peripheral components to the example device. In aspects, at least part of the techniques described for the indoor to outdoor wireless power delivery may be implemented in a distributed system, such as over a “cloud” 1424 in a platform 1426. The cloud 1424 includes and/or is representative of the platform 1426 for services 1428 and/or resources 1430.

The platform 1426 abstracts underlying functionality of hardware, such as server devices (e.g., included in the services 1428) and/or software resources (e.g., included as the resources 1430), and connects the example device 1402 with other devices, servers, etc. The resources 1430 may also include applications and/or data that can be utilized while computer processing is executed on servers that are remote from the example device 1402. Additionally, the services 1428 and/or the resources 1430 may facilitate subscriber network services, such as over the Internet, a cellular network, or Wi-Fi network. The platform 1426 may also serve to abstract and scale resources to service a demand for the resources 1430 that are implemented via the platform, such as in an interconnected device embodiment with functionality distributed throughout the system 1400. For example, the functionality may be implemented in part at the example device 1402 as well as via the platform 1426 that abstracts the functionality of the cloud 1424.

Although aspects of indoor to outdoor wireless power delivery have been described in language specific to features and/or methods, the subject of the appended claims is not necessarily limited to the specific features or methods described. Rather, the specific features and methods are disclosed as example implementations of indoor to outdoor power delivery, and other equivalent features and methods are intended to be within the scope of the appended claims. Further, various different aspects are described, and it is to be appreciated that each described aspect can be implemented independently or in connection with one or more other described aspects.

1. An electronic device configured to inductively transfer continuous power, the electronic device comprising:
a transmitter configured for operation in an indoor environment and configured to produce an electromagnetic field to inductively transfer power to a receiver, the transmitter comprising:
a transmitter coil;
a transmitter housing;
transmitter electronics; and
the receiver configured for operation in an outdoor environment and configured to receive the electromagnetic field from the transmitter, the receiver comprising:
a receiver coil;
a receiver housing; and
receiver electronics.

2. The electronic device of claim 1, wherein the receiver housing comprises a material that is resistant to ultraviolet (UV) radiation, and wherein the receiver housing is configured to protect the receiver from exposure to one or more of: precipitation, dust, wind, or sunlight.

3. The electronic device of claim 1, wherein the transmitter receives electrical power from an external power supply, and wherein the transmitter converts the electrical power received from the external power supply to the electromagnetic field.

4. The electronic device of claim 1, wherein the receiver converts the received electromagnetic field to electrical power, wherein the receiver includes a connector for providing the converted electrical power to an external electronic device, and wherein the external electronic device comprises a camera, a doorbell, an entryway interface device, a network-connected door lock, or a security sensor.

5. The electronic device of claim 4, wherein the external electronic device is mechanically connected to the receiver housing, wherein the receiver is integrated into the external electronic device, or wherein the converted electrical power is provided to the external electronic device via a cable connected to the connector of the receiver.

6. The electronic device of claim 1, wherein the power is inductively transferred via an inductive power transfer path between the transmitter and the receiver, wherein the inductive power transfer path is through a building structure, wherein the building structure includes one or more building materials, wherein the one or more building materials include glass, wood, sheetrock, insulation, or air gaps, and wherein the building structure includes a single-pane window, a double-pane window, a triple-pane window, a door, or a wall.

7. The electronic device of claim 1, wherein the transmitter, the receiver or a combination thereof are configured to provide an indication of a state of alignment between the transmitter and the receiver, and wherein the indication of the state of the alignment includes one or more of a visual indicator included in the transmitter, a visual indicator included in the receiver, or an indication provided by an application on a computing device that is communicatively coupled to the receiver or the transmitter.

8. The electronic device of claim 1, wherein the receiver or the transmitter is configured to be mounted using magnets, adhesive, adhesive tape, suction cups, or snaps.

9. The electronic device of claim 1, wherein the transmitter includes a wireless transceiver, wherein the receiver includes another wireless transceiver, wherein the wireless transceiver is coupled to the transmitter coil to use the transmitter coil as an antenna, wherein the other wireless transceiver is coupled to the receiver coil to use the receiver coil as an antenna, wherein the receiver includes a current sensor, wherein the receiver transmits a measurement of consumed current to the transmitter using the other wireless transceiver, wherein the transmitter receives the measurement of consumed current using the wireless transceiver, wherein the transmitter controls one or more parameters related to generating the electromagnetic field based on the received measurement of consumed current, and wherein the one or more parameters include a switching frequency, a switching phase, a switching duty cycle, or a voltage provided to the transmitter coil.

10. The electronic device of claim 1, wherein the electronic device is configured to detect tampering with the external electronic device or a cable between the receiver and the external electronic device, and wherein the electronic device is configured to provide an indication of the tampering to a user of the electronic device.

11. A method of inductively transferring continuous power from a transmitter device to a receiver device, the method comprising:
receiving, at the transmitter device, an indication of a required continuous power from the receiver device;
configuring one or more settings to generate an electromagnetic field to transfer the required continuous power;
based on the one or more settings, generating the electromagnetic field to transfer the required continuous power to the receiver device.

12. The method of claim 11, comprising
based on the receiving the indication of the required continuous power from the receiver device, negotiating with an external power supply to provide a voltage, a current, or a combination thereof, to the transmitter device; and
receiving external power from the external power supply based on the negotiating.

13. The method of claim 11, the one or more settings include: a voltage applied to a transmitter coil, a switching frequency, a switching duty cycle, or a switching phase.

14. The method of claim 11, comprising:
selecting a voltage to apply to a transmitter coil to optimize an efficiency of the power transfer.

15. The method of claim 14, wherein the selecting the voltage comprises selecting the lowest voltage that will provide the required continuous power.

16. A system for inductive power transfer, the system comprising:
a transmitter apparatus comprising:
a transmitter controller to configure the transmitter apparatus;
a regulator that is configurable by the transmitter controller to set a voltage to be applied to a transmitter coil;
the transmitter coil that is configured to generate an electromagnetic field; and
a coil driver that is configurable by the transmitter controller to provide a current flow to the transmitter coil;
a receiver apparatus comprising:
a receiver controller to configure the receiver apparatus;
a receiver coil that is configured to receive an electromagnetic field from the transmitter apparatus;
a rectifier to convert an alternating current from the receiver coil to a direct current; and
an output regulator that is configurable by the receiver controller to set an output voltage to be provided to an external electronic device.

17. The system of claim 16, wherein the coil driver is configured to produce an alternating the flow of a direct current, from the regulator, through the transmitter coil, wherein the coil driver comprises multiple field effect transistors (FETs) that are configured to switch a direction of the current flow through the transmitter coil to produce the alternating current flow, and wherein the alternating flow of current is effective to produce the electromagnetic field.

18. The system of claim 17, the transmitter apparatus further comprising a tuning capacitor, wherein the transmitter coil and the tuning capacitor form a resonant circuit, and wherein an inductance of the transmitter coil and a capacitance of the tuning capacitor determine a resonant frequency for generation of the electromagnetic field.

19. The system of claim 16, wherein the rectifier comprises:
four field effect transistors (FETs) configured as a full-wave bridge rectifier; and
a rectifier controller connected to a gate of each of the FETs, the rectifier controller configured to:
receive the alternating current from the receiver coil;
based on the received alternating current, determine a pair of the FETs to set to an on-state to rectify the alternating current to the direct current;
the receiver apparatus further comprising:
a current sensor configured to measure a current consumption of the external electronic device, wherein the current sensor provides an indication of the measured current to the receiver controller, and wherein the receiver controller transmits the indication of the measured current to the transmitter apparatus; and
a tuning capacitor, wherein the receiver coil and the tuning capacitor form a resonant circuit, and wherein an inductance of the receiver coil and a capacitance of the tuning capacitor tune the receiver apparatus to a frequency for reception of the electromagnetic field.

20. The system of claim 16,
the transmitter apparatus further comprising a first wireless transceiver for communication, wherein the first wireless transceiver is coupled to the transmitter coil, and wherein the transmitter coil is an antenna for wireless communication with the receiver apparatus; and
the receiver apparatus further comprising a second wireless transceiver for communication to the transmitter apparatus, wherein the second wireless transceiver is coupled to the receiver coil, and wherein the receiver coil is an antenna for wireless communication with the transmitter apparatus.
